(19) United States
(12) Patent Application Publication
(10) Pub. No.: US 2004/0137112 A1
(43) Pub. Date: Jul. 15, 2004

(54) Low glycemic index food

(76) Inventors: Saul Katz, Edmonton (CA); Valerie Price, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/707,230

(22) Filed: Nov. 28, 2003

Related U.S. Application Data
(60) Provisional application No. 60/319,742, filed on Nov. 28, 2002.

(51) Int. Cl. A23L 1/30

(52) U.S. Cl. 426/72

(57) ABSTRACT

A food item includes a relatively high carbohydrate content of about 50% or higher while maintaining a relatively low glycemic index of about 50 on a glucose standard or lower. The food item may be solid, semi-solid or liquid and may be shaped in any manner.

### CROSS REFERENCE TO RELATED APPLICATIONS

This application claims the priority benefit of U.S. Provisional Application No. 60/319,742 filed on Nov. 28, 2002 entitled “Low Glycemic Index Food”, the contents of which are incorporated herein by reference.

### BACKGROUND OF INVENTION

The present invention relates to a food having a high carbohydrate content while maintaining a low glycemic index.

Snack and meal replacement bars are typically consumed for their convenience, taste and nutritional content. Typical consumers include those attempting to lose weight by calorie reduction diets or diets based on balanced or unbalanced nutritional profiles, diabetics managing their blood sugars through a low glycemic index diet, athletes attempting to find a sustained energy source or simply those who wish to have a tasty, convenient or healthy snack. As well, there has been an increasing emphasis on the functional effect of such food bars.

Functional foods, a subset of nutraceuticals, blur the traditional dividing lines between foods and medicine. Although there is no specific definition of a functional food, it is generally agreed that they are foods marketed as having specific health or performance benefits. Therefore, functional foods may be ordinary foods that are formulated, or have components or ingredients incorporated into them, that generate a physiological benefit beyond conventional nutrition. Generally functional foods are directed at wellness or prophylaxis and address structure and function of various body systems.

For example, U.S. patent application Ser. No. 09/947,766 (Publication No. 2002-0122815) describes a food composition designed to maintain steady blood glucose levels while minimizing activation of the sympathetic nervous system. Such a food composition may be useful for treating or preventing migraines, headaches and associated conditions.

It is thought by some that reduced carbohydrate diets are beneficial to promote weight loss or are helpful to manage conditions such as diabetes. However, it is generally accepted that high-carbohydrate diets, defined as diets where greater than 55% of calories consumed are derived from carbohydrates, are recommended to promote good health, provided that the bulk of the carbohydrates are rich in polysaccharides with a low glycemic index.

Research into the concept and effect of glycemic indexing has been attracting significant interest since its conception in about 1981. The definition of glycemic index and subsequent research has lead to the knowledge that the rate of carbohydrate ingestion in the gastrointestinal tract has important implications for a number of body systems. Glycemic indexing is now considered a more useful nutritional concept than other classification systems for carbohydrates (simple/complex, starch/sugar, available/unavailable).

The glycemic index (GI) of a food is a ranking from 0-100 of the postprandial effect of a specific food on blood glucose levels. The standard for a score of 100 is pure glucose. On the scale of 1-100, scores below 55 are generally considered low by those skilled in the art.

In practical terms, the total amount of carbohydrate must also be considered when planning a low glycemic diet. This can be assessed using the concept of glycemic load. Glycemic load is defined as (GI×carbohydrate content per serving)/100. High glycemic load has been independently associated with increased risk of developing type II diabetes, cardiovascular disease and certain cancers. Glycemic indexing is a valuable and proven clinical tool in its application to diabetes management, weight control and athletics.

In recent years a number of private and university-affiliated laboratories have done extensive measurements of the GI of a broad range of foods. Concurrently the research has suggested ways to control GI while eating a mixed diet high in carbohydrates. The information provided by this research may be used by manufacturers to develop processing techniques and ingredients that tend to lower the GI of manufactured food products. The most recent definitive information was published in the American Journal of Clinical Nutrition in July 2002 as referenced below.

It is of course possible to reduce the glycemic index of a food by lowering the total carbohydrate content of that food. For example, the Body Wise® Lean Index™ Bar by Body Wise International Inc. advertises a glycemic index of 38 but has a carbohydrate content of only 40% by weight, with protein at 40% and fat at 20%. Like other nutritional bars, it is an attempt to provide a “balanced” composition of nutrients in a high protein diet. Another example is the Balance® Bar which advertises a 40-30-30 ratio of protein, carbohydrate and fat respectively, on a caloric basis. The Balance® Bar contains 44% carbohydrates on a weight basis and has a low glycemic index of less than about 50. The NuGo Nutrition™ bar has more than 50% carbohydrate but was able to achieve a GI of only about 50.

However, because of the benefits of a diet which is higher in carbohydrates while maintaining a low glycemic index, there is a need in the art for a convenient, nutritious and tasty food bar which is relatively high in carbohydrate content while maintaining a low glycemic index.

### SUMMARY OF INVENTION

This invention is intended to benefit consumers by providing a snack or meal-replacement food item that helps maintain a low glycemic index. A low glycemic index is provided without unduly reducing the carbohydrate content of the snack. The relatively higher carbohydrate content improves the taste and texture and provides a more nutritious snack than those with higher fat and protein contents. The cost of producing the snack is lowered as well. This will be of particular interest to diabetics and overweight individuals who are interested in improving their overall health.

Therefore, in one aspect, the invention comprises a processed, ready-to-eat food item comprising a protein source, a fat source and a carbohydrate source wherein the total carbohydrate content of the item is greater than about 45% by weight and the glycemic index of the item is lower than about 50 on the glucose standard (about 71 on the white bread standard). Preferably, the carbohydrate content of the food item exceeds about 50%. More preferably, the carbohydrate content exceeds about 55% and the glycemic index is lower than about 40 (57) Most preferably, the glycemic index is less than about 35 (50).

In one embodiment, the protein source comprises one or more of soy protein, whey protein and casein and the carbohydrate source comprises one or more of fructose, inulin, barley and cherries.

### DETAILED DESCRIPTION

The present invention provides for a prepared, ready-to-eat food item having a minimum carbohydrate content and a maximum glycemic index. When describing the present invention, all terms not defined herein have their common art-recognized meanings. As a food item, the present invention may be in solid, semi-solid or liquid form. In solid form, the food item may be of any shape such as a bar, a cookie, a ball or some other shape. Many limitations of the present invention are based on a numeric standard. The term “about” is used to denote a range about the figure stated which represents experimental and measurement error, using standard and accepted techniques.

Due to differences in protocols developed by researchers, glycemic index may be measured on two different scales the glucose scale and the white bread scale. Glycemic index as used herein is reported in two ways. The first number is based on the glucose scale and the number in brackets is based on the white bread standard. In every case, the two standards may be used interchangeably.

Glycemic index is determined by graphing blood glucose levels at various time intervals after ingesting the test food and determining the “area under the curve”(AUC) in comparison with the standard, which may be either glucose or white bread. Therefore a glycemic index of 50 on the white bread scale indicates the AUC of white bread is twice as large as the AUC of the test food.

In one preferred embodiment, the food item contains at least about 50% carbohydrate by weight, and about 45% at a minimum. As used herein, the threshold level for “high carbohydrate” is about 50% content by weight. While this is a somewhat arbitrary figure, to those skilled in the art, achieving a low GI with substantially less than 50% carbohydrate content is relatively simple because fats and proteins lower GI by definition. As used herein, a low GI food is one that delivers a GI of less than about 40 on the glucose scale (57), preferably below about 35 (50) and more preferably below about 30 (43), and most preferably about 25 (35).

In one preferred embodiment, the food bar contains about 56% carbohydrates and has a GI of 26+/−2.7 (33+/−3.8).

The food items of the present invention are processed from a plurality of different ingredients and are preferably ready-to-eat. They comprise a mixture of ingredients which include sources high in protein, high in carbohydrate and high in fat. While a protein, a carbohydrate and a fat source may be selected and mixed together to create a food item meeting the definition of high-carbohydrate-low GI, as used herein, it is preferable to choose ingredients which when combined appropriately meet those criteria and are palatable in terms of taste and consistency.

The glycemic index of a product may not be predictable from its composition or from similar foods but research continues to suggest that there is a relationship between the GI of the ingredients in a mixed meal (or processed food) and the final GI. Adding the GI numbers of the ingredients is only an approximate method for determining GI. It is necessary to measure the AUC using standard protocols for an accurate measure. We believe certain principles apply in the formulation of low GI nutrition bars which enhance the features that increase the probability of a mixed food having a low glycemic index. In the preferred embodiment, ingredients were chosen for their respective glycemic index, particle size, fiber content, monosaccharide and disaccharide profile and their functionality in making a tasty nutritious food item.

Ingredients of a Preferred Embodiment Toasted soy pieces are a preferred ingredient in the formula. They are all natural, processed with water and heat only, and have a bland roasted flavor without the typically beany soy flavour of other soy products. They are high in protein and have about 25.5% carbohydrate, 20.3% fibre and less than 6% sugar. The primary functional characteristics are to provide structure and body to the bar. While this product does not have a measured glycemic index, tables published in the American Journal of Clinical Nutrition show a glycemic index range for dried soy beans of 15-10.

Inulin is an all natural functional food ingredient, providing 100% soluble dietary fibre. It is prepared by a process of extraction and purification from the chicory root and analytically certified for nutritional applications. It is further processed to optimize its solubility, dispersion and flow. It is a white, neutral and slightly sweet powder. The total carbohydrate content is 95% with inulin/FOS (fructo-oligosaccharides) at 90%+2.2. Ash is about 0.10%. Moisture is about 5%. The modal chain length is 9 monomer units. DP (degree of polymerization—chain length) range is 2-50. No glycemic index is available, however, inulin is known to form a viscous mass in the intestine and this tends to lower GI. In this regard, inulin acts physiologically as a fibre, but it is not detected as fibre using standard AOAC methodology.

Toasted barley flakes are milled, flaked grains of barley that have been heated so a cooked or toasted flavour is achieved. They are 75% carbohydrate, none of which is sugar. Functionally, they add texture to the product. The GI of barley is generally in the range of 25+/−1.

Dried cherries are a preferred ingredient. The cherries are dried to a specific moisture range and may be sprayed with sunflower oil to prevent sticking. They are not infused with sugars or juice. They are about 84% carbohydrate about half of which is sugar, and since this is a fruit, one can assume the sugar is primarily fructose. Fresh cherries have a glycemic index of 22, which is very low for a fruit. Functionally, dried cherries add flavour and texture.

The food bar may include one or more of the following ingredients, preferably in quantities less than 5% of the formula: soy nuggets, whey isolate and calcium caseinate. Each of these is a known high quality protein source.

The dry ingredients may be mixed with a binder or liquid ingredients which serve to hold the solid ingredients together in a mass and to contribute to flavour, mouth feel and shelf life.

Dried plum puree is a known commercial fat replacer and binder that contains dried plums, corn syrup, fructose and glycerine. It is 67% carbohydrate and just over half of that is sugar. Its primary function is to bind the dry ingredients together. No glycemic index is available although plums have an average GI of 39+/−15, and fructose 11+/−1.

Almond paste is produced from almonds which are roasted for flavor development and milled to produce a consistent paste. The paste contains 24.5% carbohydrate and 54.2% fat. The primary function is to provide a smooth mouth feel. While a GI value has not been determined for almonds, the high fat content suggests that they would have a low GI.

Liquid fructose is melted crystalline fructose that is 99.5% pure fructose. It″s primary function is binding and sweetening and it has a GI of 11+/−1.

Agave syrup is derived from the carbohydrate present in the Agave plant. It is about 70% pure fructose, is primarily used for binding and has a GI of 11+/−1.

Glycerine is present in one preferred embodiment less than about 5%. No glycemic index is available as this is generally considered a non-glycemic carbohydrate.

Artificial or natural flavouring may be added to improve or change the taste characteristics. Functional additives that improve processing and food safety may be added. These could include flavour maskers, anti-microbial agents and anti-oxidants. Vitamin and mineral supplements may be added. In order to process the food mass into a solid item, such as a shaped bar or similar product, the ingredients must be an appropriate mix of hydrateable carbohydrates (starch, sugar and fiber) and proteins to form a mass with sufficient cohesion to bind and hold its shape during and after processing. While there is some flexibility in the ratio of fluids and solids, this part of the formulation is critical to the remaining steps in the process. It is also critical to the shelf life of the product.

Many commercial bars are coated in chocolate or yogurt enrobing material that provides an additional barrier to moisture loss and subsequent drying of the product. While enrobing the bar in this manner is unlikely to have a major effect on the GI due to the high fat content of most coatings, nutritionally the product would drop to about 49% carbohydrate which is below the preferred standard defined herein for a high carbohydrate food. It may still, however, fall within the scope of the present invention. Additionally, the coating may be applied to only a portion of the bar such as by bottom-coating or drizzle-coating, in which case the coating will have less impact on the nutritional profile of the bar.

In a preferred embodiment, there are two primary methods of producing a food product of the present invention. In both methods, the wet ingredients are mixed together at ambient room temperature. The ingredients are blended until a smooth consistency is reached. The dry ingredients are blended separately until they are evenly mixed. The dry ingredient blend is added to the wet ingredients and mixed until a consistent mass is formed. The mass adheres to itself and does not stick to the sides of the mixing bowl. It is a soft dough like mass that can be easily manipulated and may slump but does not flow. The forming, and packaging of nutrition bars is a well understood technology with several companies producing high quality equipment designed specifically to cold extrude or slab form bars. Patents exist that describe the process in detail. For example, U.S. Pat. No. 5,776,887 describes this process with references to other similar patents. The composition of this bar is unique but the attributes of the food mass that make it machineable are similar to the attributes of food bars that are currently formed on production equipment. Those attributes are stickiness, density and flow characteristics. Therefore, well-known and conventional food processing techniques may be implemented to form food items of the present invention.

The distinction between the two alternative methods in a preferred embodiment comes after the mixing step. One alternative may be described as an extrusion method where the food mass is forced through a die onto a moving conveyor belt so the height and width are determined by the size of the extrusion die. The “ropes” of extruded product are cooled and cut to length by a guillotine style cutter. The other alternative method involves compressing the mass into a large slab of even thickness between two large rollers that are typically temperature controlled. The temperature can be controlled to help the mass release from the rollers. Circular knives are used to cut the bars to width. A spreading conveyor separates the bar “ropes” and feeds them in to the same guillotine cutter that is used in the extrusion technique.

The techniques used to manufacture nutrition and snack bars have become common knowledge to those skilled in the art and large equipment companies produce standard equipment that is capable of making the low glycemic bars described herein. Descriptions of various parts of the process may also be found in the prior art patent literature.

### EXAMPLE

The following description of a specific embodiment is intended to be exemplary of the claimed invention but is not intended to be limiting thereof.

The following ingredients were combined in the weight amounts indicated. Individual 50 gram bars were formed comprising the following ingredients in the following proportions by weight:

Diced toasted soy pieces 19.4%

Inulin 10%

Toasted barley flakes 7.4%

Dried cherries 5.6%

Soy nuggets 4.1%

Whey isolate 1.9%

Calcium caseinate 1.9%

Plum Puree 16.8%

Almond butter 12.1%

Liquid fructose 7.4%

Agave nectar 7.4%

Glycerine 4.7%

Natural flavour 1.3%

Each 50 gm bar thus formed had the following nutritional profile:

Total Carbohydrate28 gm (56%)

Sugar 10 gm

Dietary Fibre 9 gm

Protein 9 gm

Fat 6 g m

Saturated Fat 0.5 gm

Cholesterol 0 mg

Each 50 gm bar provided 190 calories, of which 56% comes from carbohydrates, 18% comes from protein and 26% comes from fat.

This exemplary formulation was tested at the Glycaemic Institute in Toronto, Canada and found to have a glycemic index of 26+/−3 on the glucose standard and 33+/−4 on the white bread standard.

As will be apparent to those skilled in the art, various modifications, adaptations and variations of the foregoing specific disclosure can be made without departing from the scope of the invention claimed herein. Variations may include the use, addition or substitution of other low glycemic ingredients, fibres, binding systems and other minor ingredients. The various features and elements of the described invention may be combined in a manner different from the combinations described or claimed herein, without departing from the scope of the invention.

### REFERENCES

The following references are incorporated herein by reference in their entirety.

Painter, J. E., Prisecaru, V. I. “The effects of Various Protein and Carbohydrate Ingredients in Energy Bars on Blood Glucose Levels in Humans”, Cereal Foods World. June 2002 VOL.47 NO 6.

Foster-Powell, Kaye, Holt, Susanna H A, Brand-Millar, Janette C. “International table of Glycemic index and glycemic laod vlues:2002”, Am J Clin Nutr 2002; 76:5-56.

Brand Millar Jennie, et al. The Glucose Revolution, the Authoritative Guide to the Glycemic Index, (Marlowe and Company, New York, 1999).

1. A processed, ready-to-eat food item comprising a protein source, a fat source and a carbohydrate source wherein the total carbohydrate content of the food item is greater than 45% by weight and the glycemic index of the food item is lower than 50 (71).

2. The food item of claim 1 wherein the carbohydrate content exceeds 50%.

3. The food item of claim 2 wherein the carbohydrate content exceeds about 55% and the glycemic index is lower than about 40(57).

4. The food item of claim 3 wherein the glycemic index is less than about 35(50).

5. The food item of claim 1 wherein the protein source comprises one or more of soy protein, whey protein and casein, or mixtures thereof.

6. The food item of claim 5 wherein the carbohydrate source comprises one or more of fructose, inulin, barley and cherries, or mixtures thereof.

7. The food item of claim 6 comprising a mixture of the following ingredients in the weight percentage range indicated:
Toasted soy pieces 15% to 25%
Inulin 5% to 15%
Toasted barley flakes 5% to 10%
Dried cherries 0% to 10%
Soy nuggets 0% to 5%
Whey isolate 0% to 5%
Calcium caseinate 0% to 5%
Plum Puree 10% to 20%
Almond paste 5% to 20%
Liquid fructose 5% to 20%
Agave nectar 5% to 20%
Glycerine 0% to 10%
Flavour 0% to 5%
